(19) United States
(12) Patent Application Publication
(10) Pub. No.: US 2016/0342275 A1
(43) Pub. Date: Nov. 24, 2016

(54) METHOD AND DEVICE FOR PROCESSING TOUCH SIGNAL

(71) Applicant: Shenzhen China Star Optoelectronics Technology Co., Ltd., Shenzhen City, Guangdong (CN)

(72) Inventors: Ruhai FU, Shenzhen, Guangdong (CN); Yung-lun LIN, Shenzhen, Guangdong (CN); Chun-kai CHANG, Shenzhen, Guangdong (CN); Jie QIU, Shenzhen, Guangdong (CN); Chengliang YE, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/425,630

(22) PCT Filed: Dec. 9, 2014
(86) PCT No.: PCT/CN2014/093353

§ 371 Date: Mar. 3, 2015

(30) Foreign Application Priority Data
Nov. 26, 2014 (CN) 201410693049 .X

(51) Int. Cl. G06F 3/041; G06F 3/044

(52) U.S. Cl. CPC G06F 3/0418; G06F 3/044

(57) ABSTRACT

The present application provides a method and device for processing touch signal. The method for processing touch signal comprises the steps of: when a touch action is detected, collecting a detected feature information of a shape and/or a size of a touched area in correspondence with the touch action; comparing the detected feature information with a standard feature information stored in a preset data storage, wherein the standard feature information comprises a finger feature information of the shape and/or the size of a touched area in correspondence with a finger or a stylus pen touch, and further comprises a hand feature information of the shape and/or the size of a touched area in correspondence with palm touch except fingers; and performing a first process in correspondence with the finger feature information if a compare result of the comparing is that the detected feature information matches the finger feature information, and performing a second process in correspondence with the hand feature information if the compare result is that the detected feature information matches the hand feature information. The present application effectively prevents the touch sensing system from touch signal misjudgment.

### FIELD OF THE INVENTION

The present invention relates to a touch panel technique field, and more particularly to a method and device for processing touch signal.

### BACKGROUND OF THE INVENTION

Along with the popularity of computer and other electronic devices, the requirement of input method of mobile phone and tablet PC for users increases so that the conventional keyboard is not good enough for input and peoples tend to use a convenient touch input. Touch sensing system, which is one of the apparatuses for inputting data, is more and more popular. For example, the touch sensing system could be found in workshop, warehouse, manufacturing machine, restaurant, etc. for using on the hand-held personal digital assistant, automated teller machine, etc.

However, the conventional touch sensing system is difficult to precisely identify a signal input by using a stylus pen, a signal generated in response to a situation of putting a hand on a touch panel, and a signal generated in response to a situation of touching the touch panel by fingers.

### SUMMARY OF THE INVENTION

The primary technique problem to be solved by the present invention is to provide a method and device for processing touch signal which can precisely determine the touch signal to reduce misjudgment.

In order to solve the technique problem mentioned above, one technique solution adopted by the present invention is to provide a method for processing touch signal comprising the steps of:

when a touch action is detected, collecting a detected feature information of a shape and/or a size of a touched area in correspondence with the touch action;

comparing the detected feature information with a standard feature information stored in a preset data storage, wherein the standard feature information comprises a finger feature information of the shape and/or the size of a touched area in correspondence with a finger or a stylus pen touch, and further comprises a hand feature information of the shape and/or the size of a touched area in correspondence with palm touch except fingers;

determining whether the touch action matching the finger feature information and the touch action matching the hand feature information are detected at the same time; and

waiting a predetermined duration to return to the step of detecting the touch action if a determine result of the determining is yes, then performing again the step of comparing the detected feature information with the standard feature information stored in the preset data storage, and performing a first process in correspondence with the finger feature information and/or a second process in correspondence with the hand feature information if a compare result of the comparing is still that the detected feature information matches the finger feature information and the hand feature information, otherwise the step of the touch action being detected is returned without performing the first process and/or the second process.

Wherein, the first process is a normal touch responding processing, and the second process is to ignore the touch action and is not responding to the touch action made by hand.

Wherein, the step of determining whether the touch action matching the finger feature information and the touch action matching the hand feature information are detected at the same time comprises:

determining whether the touch action matching the finger feature information and the touch action matching the hand feature information are detected at the same time, wherein the finger feature information comprises a touch feature information of the finger and the stylus pen.

In order to solve the technique problem mentioned above, another technique solution adopted by the present invention is to provide a method for processing touch signal comprising the steps of:

when a touch action is detected, collecting a detected feature information of a shape and/or a size of a touched area in correspondence with the touch action;

comparing the detected feature information with a standard feature information stored in a preset data storage, wherein the standard feature information comprises a finger feature information of the shape and/or the size of a touched area in correspondence with a finger or a stylus pen touch, and further comprises a hand feature information of the shape and/or the size of a touched area in correspondence with palm touch except fingers; and

performing a first process in correspondence with the finger feature information if a compare result of the comparing is that the detected feature information matches the finger feature information, and performing a second process in correspondence with the hand feature information if the compare result is that the detected feature information matches the hand feature information.

Wherein, the first process is a normal touch responding processing, and the second process is to ignore the touch action and is not responding to the touch action made by hand.

Wherein, before performing the first process or the second process, the method comprises:

determining whether the touch action matching the finger feature information and the touch action matching the hand feature information are detected at the same time; and

if a determine result of the determining is yes, the first process and/or the second process is performed, otherwise the step of the touch action being detected is returned without performing the first process and/or the second process.

Wherein, the step of determining whether the touch action matching the finger feature information and the touch action matching the hand feature information are detected at the same time comprises:

determining whether the touch action matching the finger feature information and the touch action matching the hand feature information are detected at the same time, wherein the finger feature information comprises a touch feature information of the finger and the stylus pen.

Wherein, a step before the step of performing the first process, after the compare result is that the detected feature information matches the finger feature information, comprises:

waiting a predetermined duration to return to the step of detecting the touch action, then performing again the step of comparing the detected feature information with the standard feature information stored in the preset data storage, and performing the first process in correspondence with the finger feature information if the compare result is still that the detected feature information matches the finger feature information, and performing the second process in correspondence with the hand feature information if the compare result is still that the detected feature information matches the hand feature information.

In order to solve the technique problem mentioned above, the other technique solution adopted by the present invention is to provide a device based on a method for processing touch signal, which comprises a detection module, a comparison module and a processing module; wherein

the detection module collects a detected feature information of a shape and/or a size of a touched area in correspondence with a touch action when the touch action is detected;

the comparison module compares the detected feature information with a standard feature information stored in a preset data storage; and

the processing module performs a first process in correspondence with a finger feature information if a compare result of the comparing of the comparison module is that the detected feature information matches the finger feature information, and performs a second process in correspondence with a hand feature information if the compare result is that the detected feature information matches the hand feature information.

Wherein, the first process of the processing module is a normal touch responding processing, and the second process is to ignore the touch action and is not responding to the touch action made by hand.

Wherein, the device further comprises:

a determination unit determining whether a touch action matching the finger feature information and a touch action matching the hand feature information are simultaneously detected before performing the first process or the second process; and

the processing module performs the first process and/or the second process if a determine result of the determination unit is yes, otherwise the processing module does not perform the first process and/or the second process.

Wherein, the finger feature information comprises a touch feature information of a finger and a stylus pen.

Wherein, before the processing module performs the first process, the comparison module compares the detected feature information with the standard feature information again; and, if the compare result of the comparison module is still that the detected feature information matches the finger feature information, the processing module performs the first process in correspondence with the finger feature information, and, if the compare result is still that the detected feature information matches the hand feature information, the processing module performs the second process in correspondence with the hand feature information.

The efficacy of the present invention is that, different from the conventional technique, the present invention collects a detected feature information of a shape and/or size of a touched area corresponding to a touch action when the touch action is detected, compares the detected feature information and a standard feature information stored in a preset data storage, and performs corresponded process according to a result of comparison. By using the method above, because the shapes and sizes of the touched areas formed by finger touching and hand touching are different from each other, and the shape and size of each touching area is with rules of specific order and feature, the present invention establishes signal data storage in the touch sensing system, compares the standard feature information stored in the preset data storage with the detected feature of the shape and/or size of the collected touch action, and then correspondingly processes the matched touch action, so that the touch sensing system could be effectively prevented from touch signal misjudgment without division of the touch panel into specific areas and limitation of user operation areas, and the user experience is improved.

### BRIEF DESCRIPTION OF THE DRAWINGS

FIG. 1 is a flow chart of a first embodiment of the method for processing touch signal according to the present invention.

FIG. 2 is a flow chart of a second embodiment of the method for processing touch signal according to the present invention.

FIG. 3 is a flow chart of a third embodiment of the method for processing touch signal according to the present invention.

FIG. 4 is a time chart showing variation of a touch signal value collected at predetermined time in the third embodiment of the method for processing touch signal according to the present invention.

FIG. 5 is a flow chart of a fourth embodiment of the method for processing touch signal according to the present invention.

FIG. 6 is a schematic diagram of touch signals detected by the method for processing touch signal according to the present invention.

FIG. 7 is a structure schematic diagram of an embodiment of the device for processing touch signal according to the present invention.

### DETAILED DESCRIPTION OF PREFERRED EMBODIMENTS

The present invention will now be described more specifically with reference to the following embodiments and drawings.

In order to ensure that the present invention could be performed normally, a touch panel of a terminal of the present invention is the touch panel having ability of collecting a shape and/or a size of a touched area corresponding to a touch action. The touched areas corresponding to operations by finger touching, stylus pen touching, and hand touching of users on the touch panel are with stable shapes and sizes. Please refer to FIG. 6, which is a schematic diagram of touch signals detected by the method for processing touch signal according to the present invention. For example, when it is stable, the touched area in correspondence with the stylus pen touching is labeled as 602, the touched area in correspondence with the finger touching is labeled as 603, and the touched area in correspondence with the hand touching is labeled as 601. Generally, a rule of the shape and the size of the touched area 602 in correspondence with the stylus pen touching and the touched area 603 in correspondence with the finger touching would vary in a certain range according to different touch strength, wherein the touched area 602 in correspondence with the stylus pen is slightly smaller than the touched area 603 in correspondence with the finger touching. The shape of the area touched by hand could be different and with various sizes according to gesture variation, and obeys a certain rule in normal operation. The sizes of the hand touched area 601, finger touched area 603 and the stylus pen touched area 602 are sequentially reduced. Wherein, the hand is referred to a rest part of a palm except fingers and corresponds to the touched area, and is normally referred to the root of the palm, that is, when a touch operation is performed, the palm is supported by the root of the palm so that it is convenient for finger to proceed the touch action on the touch panel, which is similar to the situation of writing by a Chinese writing brush.

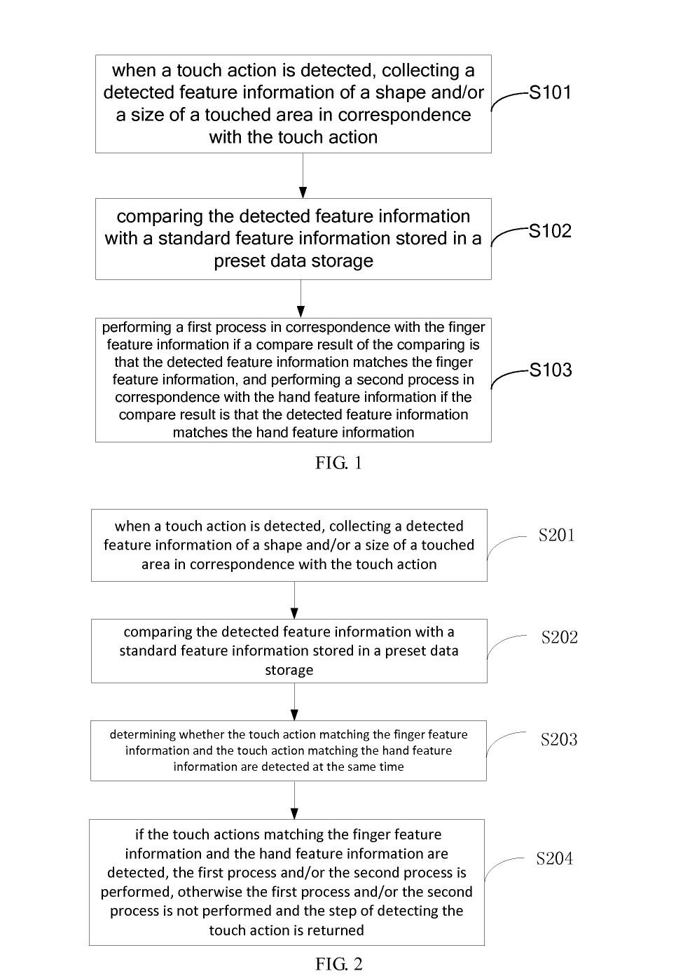

Please refer to FIG. 1, which is a flow chart of a first embodiment of the method for processing touch signal according to the present invention. The present invention provides a method for processing touch signal comprising the steps of:

S101: when a touch action is detected, collecting a detected feature information of a shape and/or a size of a touched area in correspondence with the touch action.

When the touch panel of the terminal is turned on, the touch action occurs through touching of fingers, stylus pen and/or hand by users, and the terminal collects and records the detected feature information of the shapes and/or sizes of the touched areas in correspondence with all the touch actions.

The detected feature information might be fingers, stylus pens or hands. The application circumstances at this time is that the operation is made by touching the touch panel through finger, stylus pen or hand only. Moreover, it could be lips or noses.

S102: comparing the detected feature information with a standard feature information stored in a preset data storage.

Compare the detected feature information recorded in the step S101 with the standard feature information pre-stored in the preset data storage. Wherein, the standard feature information, comprising a finger feature information of the shape and/or the size of a touched area in correspondence with a finger or a stylus pen touch, and further comprises a hand feature information of the shape and/or the size of a touched area in correspondence with palm touch except fingers, could be self-defined or preset while being manufactured.

S103: performing a first process in correspondence with the finger feature information if a compare result of the comparing is that the detected feature information matches the finger feature information, and performing a second process in correspondence with the hand feature information if the compare result is that the detected feature information matches the hand feature information.

According to the compare result of the step S103, the first process in correspondence with the finger or stylus pen feature information is performed if the compare result is that the detected feature information is the same as the finger or stylus pen feature information of the standard feature information pre-stored in the terminal data storage; and the second process in correspondence with the hand feature information is performed if the compare result is that the detected feature information matches the hand feature information of the standard feature information pre-stored in the terminal data storage. Wherein, the first process is a normal touch responding processing, and the second process is to ignore the touch action and is not responding to the touch action made by hand.

The terminal of the present embodiment collects the detected feature information of the shape and/or size of the touched area corresponding to the touch action through a detection module, and then compares the detected feature information with the standard feature information pre-stored in the terminal, and, if the compare result is that the detected feature information matches the standard feature information, the corresponded process is performed. Therefore, it is not necessary to specifically divide the touch panel into areas, and all have to do is to establish a signal data storage in the touch sensing system so that the corresponded process could be completed and the user experience could be improved through comparing the touch signal with the signal data storage.

In a specific embodiment, the preset standard feature information could be composed of feature and/or stylus pen feature information. The feature information of the detected touch action is compared with the preset standard feature information, and, if the compare result is a match, a first process in correspondence with the finger and/or stylus pen feature information is performed, and, if it is not a match, a second process is performed. Wherein, the first process is a normal touch responding processing, and the second process is to ignore the touch action so that no process is performed.

Please refer to FIG. 2, which is a flow chart of a second embodiment of the method for processing touch signal according to the present invention. The present invention provides a method for processing touch signal, which comprises the steps of:

S201: when a touch action is detected, collecting a detected feature information of a shape and/or a size of a touched area in correspondence with the touch action.

S202: comparing the detected feature information with a standard feature information stored in a preset data storage.

The steps from S201 to S202 are similar to the steps from S101 to S102 in the previous embodiment, and are not described again here. The application circumstances of this embodiment is that the touch panel is touched simultaneously by hand and finger, or by hand and stylus pen. The detected feature information could be the finger or the stylus pen, and the hand.

S203: determining whether the touch action matching the finger feature information and the touch action matching the hand feature information are detected at the same time.

Determine whether the touch action matching the finger feature information and the touch action matching the hand feature information are detected by the terminal at the same time according to the compare result of the step S202.

S204: if the touch actions matching the finger feature information and the hand feature information are detected, the first process and/or the second process is performed, otherwise the first process and/or the second process is not performed and the step of detecting the touch action is returned.

According to the determine result of the step S203, the first process and/or second process is performed if the terminal detects the touch actions matches the finger feature information and the hand feature information simultaneously, otherwise the first process and/or the second process is not performed and the step of detecting the touch action is returned. Wherein, the finger feature information comprises a touch feature information of the finger and the stylus pen.

When the terminal screen is turned on, the terminal collects the detected feature information of the shapes and/or sizes of the touched areas in correspondence with all the touch actions through a detection module, and then compares the detected feature information with the standard feature information pre-stored in the terminal to determine whether the touch actions matching the finger feature information and the hand feature information are detected simultaneously. If the touch actions corresponding to the finger feature information and the hand feature information are detected simultaneously, and the detected feature information matches with the pre-stored standard feature information (a preliminary determination can be performed according to the size of the finger, hand and stylus pen before comparing the detected feature information and the pre-stored standard feature information, wherein the largest one is the touched area of the hand touch information, and then are the finger touch information and the stylus pen touch information when the touch signal is stable), the corresponded first process and/or second process is performed. If the touch action of the finger feature information and the hand feature information is not simultaneously detected, no process is performed. If a hand feature information and a plurality of finger and/or stylus pen feature information are detected, only the finger and/or stylus pen feature information detected earliest is deemed as an effective touch. Therefore, the terminal processes the touch actions, which are effective and match the pre-stored feature information, only when the touch actions of the finger feature information and the hand feature information exist simultaneously so as to be prevented from misjudgment caused by other touch actions.

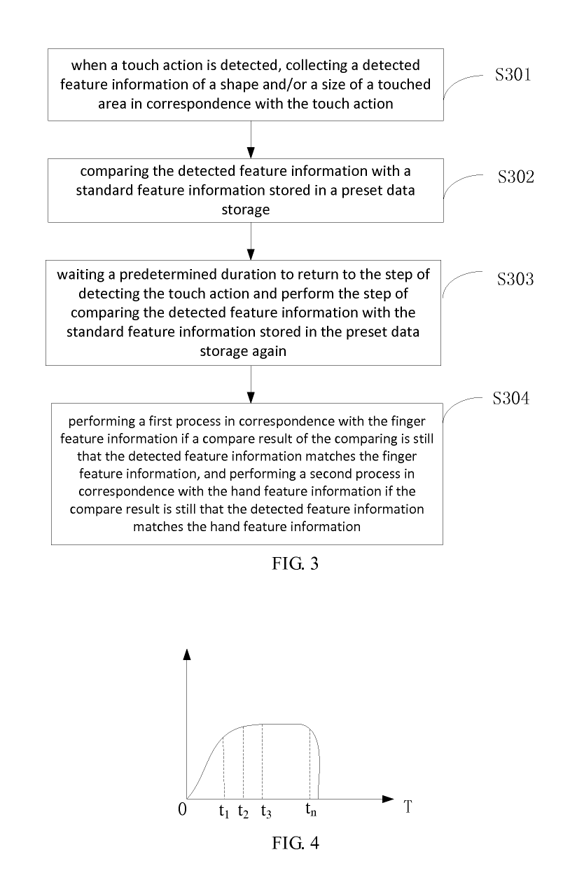

Please refer to FIG. 3, which is a flow chart of a third embodiment of the method for processing touch signal according to the present invention. The preset invention provides a method for processing touch signal, which comprises the steps of:

S301: when a touch action is detected, collecting a detected feature information of a shape and/or a size of a touched area in correspondence with the touch action.

S302: comparing the detected feature information with a standard feature information stored in a preset data storage.

The steps from S301 to S302 are similar to the steps from S101 to S102 in the previous embodiment, and are not described again here. The application circumstances of this embodiment is for improving the precision of comparing the touch signals to compare the stable touch signal with the preset standard touch signal for twice or more times.

S303: waiting a predetermined duration to return to the step of detecting the touch action and perform the step of comparing the detected feature information with the standard feature information stored in the preset data storage again.

In a specific embodiment, when the hands, fingers and stylus pens touch the touched area, the shape and/or size of the touch signal on the touched area collected by the terminal varies with time. Please refer to FIG. 4 at the same time. FIG. 4 is a time chart showing value variation of a touch signal collected at predetermined time in the third embodiment of the method for processing touch signal according to the present invention. When the time point is 0, there's no touch action. When it is between time points 0 to t₁, a touch begins. The touch action begins before the time point t₁ and the shape and size of the touched area is not stable. The shape and size of the touched area becomes stable from the time point t₁, and the touch action ends at time point tₙ. Assuming the predetermined time duration is set to t, the compared touch action in the step S302 is the touch action at the time point t₁, the step S301 is returned at the time point t₂ spaced from the time point t₁by the predetermined time duration t to detect the touch action again, and the step S302 is performed again to compare the touch action detected at the time point t₂, at which the touch signal is stable, with the standard feature information in the preset data storage. After that, step S304 is entered. In some specific embodiments, the comparing steps can be further performed continuously for at least two times, i.e., the stable touch signal at the time point t₃ spaced from the time point t₂ by the predetermined time duration t is compared with the standard feature information in the preset data storage. The steps of detecting and comparing can be repeated for many times in order to ensure the compare result.

In some specific embodiments, the size of the touched area is allowed to be changed within a certain range when the shape of the touched area of the feature information of the touch action is the same in order to prevent the size of the detected feature information of the collected touch action from being not totally the same as the preset standard feature information due to different strength of the touch action. Or, a maximum and a minimum shape is set for the same touch action in the standard feature information so that, if the shape of the touched area matches the standard feature information and the size of the detected feature information is within the range of the preset maximum and the minimum feature information when the detected feature information is stable, the compare result is that the detected feature information matches the standard feature information.

S304: performing a first process in correspondence with the finger feature information if a compare result of the comparing is still that the detected feature information matches the finger feature information, and performing a second process in correspondence with the hand feature information if the compare result is still that the detected feature information matches the hand feature information.

In the embodiment, the terminal performs a former detecting and comparing and then performs a latter detecting and comparing. If the compare result of the latter comparing is still that the detected feature information matches the finger feature information, the first process in correspondence with the finger feature information is performed. If the compare result is still that the detected feature information matches the hand feature information, the second process in correspondence with the hand feature information is performed. The terminal ensures that the touch action is the same as the pre-stored standard touch feature information and effectively avoids touch action misjudgment through performing the step of detecting and comparing for at least two times.

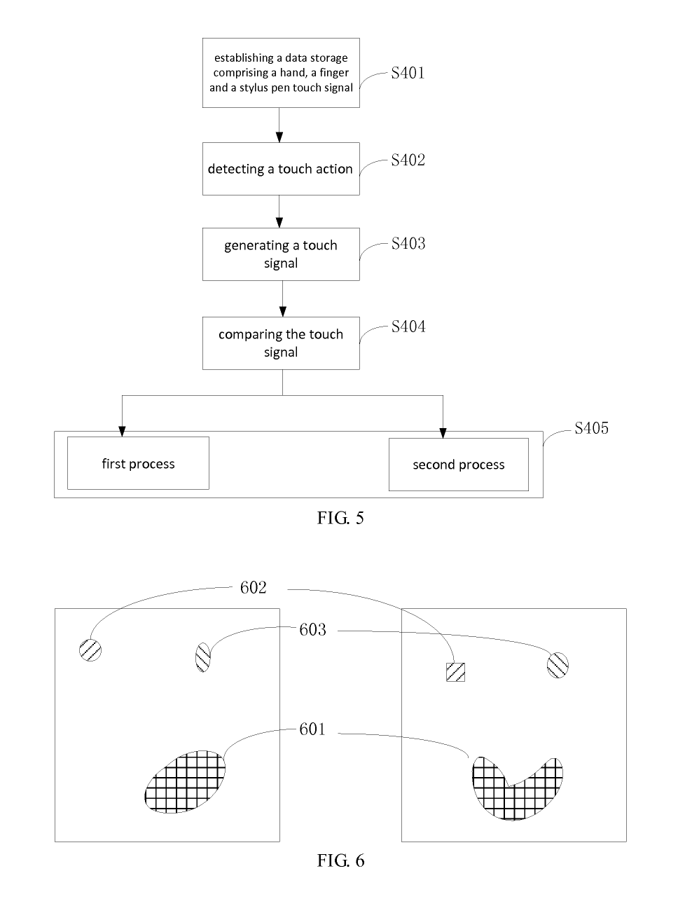

Please refer to FIG. 5, which is a flow chart of a fourth embodiment of the method for processing touch signal according to the present invention. The present invention provides a method for processing touch signal, which comprises the steps of:

S401: establishing a data storage comprising a hand, a finger and a stylus pen touch signal.

The terminal is turned on, a standard touch signal data storage system is established, touching the touch panel by hand, finger and stylus pen, and collecting the feature information of the shape and size of the touched area as shown in FIG. 6, which is a schematic diagram of touch signals detected by the method for processing touch signal according to the present invention and comprises the hand touched area 601, the finger touched area 603 and the stylus pen touched area 602. A hand touch signal data storage, a finger touch signal data storage and a stylus pen touch signal data storage are built as the standard touch signal data storage based on the feature information of the shape and size of the touched area.

S402: detecting a touch action.

A duration of detect the touch action is preset, and, during an input procedure, a feature information of a shape and a size of each touched area is collected during each preset duration. The detected touch signal collected here is the finger and/or the stylus pen and/or the hand touch feature information.

S403: generating a touch signal.

A touch signal based on the feature information of the shape and size of the touched area is formed for the touch action with variation of the feature of the shape and size of the touched area during a predetermined duration.

S404: comparing the touch signal.

The touch signal is compared with the signal data storage in accordance with the feature information of the shape and size of the collected touched area.

S405: processing the touch signal.

The usage of users generally comprises three conditions of: 1. touching the touch panel by fingers or stylus pens similar to the condition of touching mobile phone by fingers; 2. touching the touch panel by fingers/stylus pens and hands, i.e. supporting the whole palms by root of the palm during touch operation so as to make the touch operation by finger on the touch panel be easier; and 3. touching the touch panel by stylus pens, fingers and hands, i.e., the stylus is grasped by fingers, and the whole palm is supported by the hand and fingers through touching the touch panel so as to make the operation of stylus pen be easier, which is similar to the condition of writing words. According to the compare result generated by comparing the touch signal and the signal data storage, the first process is performed because it is in the first condition if the compare result of the detected feature information is that it is matched with the finger or the stylus pen touch signal data storage; the first process is performed on the touch signal matching the finger/stylus pen touch signal and the second process is performed on the touch action matching the hand touch signal because it is in the second condition if the compare result is that it is matched with the finger/stylus pen touch signal and the hand touch signal data storage; and the first process is performed on the stylus pen touch signal and the second process is performed on the finger and the hand touch signal because it is in the third condition if the compare result of the detected feature information is that the finger, the stylus pen and the hand touch signals all matches the preset data storage. Wherein, the first process is a normal touch responding processing, and the second process is to ignore the touch action and is not responding to the touch action.

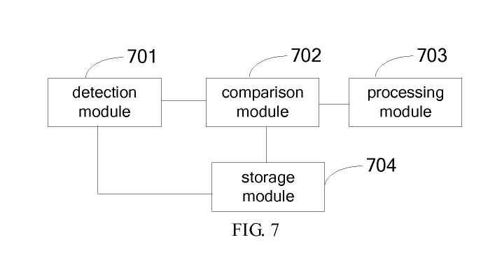

Please refer to FIG. 7, which is a structure schematic diagram of an embodiment of the device for processing touch signal according to the present invention. The present invention provides a device for processing touch signal, which comprises a detection module 701, a comparison module 702, a processing module 703 and a storage module 704.

The detection module 701, the comparison module 702 and the processing module 703 are connected in sequence, wherein the storage module 704 further connected to the comparison module 702 and the detection module 701, respectively.

The detection module 701 detects a touch action when a terminal screen is turned on, collects a detected feature information of the shape and/or size of a touched area corresponding to the touch action, and stored the collected detected feature information in the storage module 704 or temporarily registers in a terminal memory (not shown).

The storage module 704 stores the data storage pre-storing the standard feature information. Wherein, the standard feature information comprises a finger feature information of the shape and/or the size of the touched area in correspondence with finger or stylus pen touch, and further comprises a hand feature information of the shape and/or the size of the rest part of a palm except the fingers. The standard feature information could be self-defined or preset during manufacturing.

The comparison module 702 compares the detected feature information detected by the detection module 701 with the standard feature information stored in the preset data storage.

In the embodiment, the terminal collects the detected feature information of the shape and/or the size of the touched area in correspondence with the touch action through the detection module 701, and then compares the detected feature information with the standard feature information pre-stored in the storage module 704. If a compare result of the comparing is that the detected feature information matches the pre-stored standard feature information, the processing module 703 performs corresponded process. By doing so, it is unnecessary for users to put hand, fingers and stylus pen on specific areas, respectively, and hand, fingers and stylus pen could be put at will. The system could identify effective touch signals and perform corresponded process so as to improve user experience.

In some specific embodiments, the processing module 703 could comprises a determination unit (not shown), which determines whether the detection module 701 simultaneously detects the touch actions matching the finger feature information and the hand feature information. If the detection module 701 simultaneously detects the touch actions matching the finger feature information and the hand feature information pre-stored in the storage module 704, the first process and/or the second process is performed, otherwise the first process and/or the second process is not performed. Wherein, the finger feature information comprises a touch feature information of the finger and the stylus pen. The determination unit determines whether the touch actions of the finger feature information and the hand feature information are detected simultaneously, and, if the touch actions of the finger feature information and the hand feature information are simultaneously detected and the detected feature information matches the pre-stored standard feature information, the processing module performs the corresponded first process and/or the second process. If the touch actions of the finger feature information and the hand feature information are not simultaneously detected, no process is performed. Therefore, the terminal only processes the touch actions which match the pre-stored feature information and are effective when the touch actions of the finger feature information and the hand feature information exist simultaneously, so as to improve the user experience.

In some specific embodiments, a duration can further be preset. The detected feature information detected by the detection module 701 and the standard feature information pre-stored in the storage module 704 are compared with each other for a second time or further time during the preset duration, and, if the compare result is still that the detected feature information matches the finger feature information, the first process in correspondence with the finger feature information is then performed, or, if the compare result is still that the detected feature information matches the hand feature information, the second process in correspondence with the hand feature information is then performed. Wherein, the first process is a normal touch responding processing, and the second process is to ignore the touch action and is not responding to the touch action made by hand.

Embodiments of the present invention have been described, but not intending to impose any unduly constraint to the appended claims Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A method for processing touch signal, comprising the steps of:
when a touch action is detected, collecting a detected feature information of a shape and/or a size of a touched area in correspondence with the touch action;
comparing the detected feature information with a standard feature information stored in a preset data storage, wherein the standard feature information comprises a finger feature information of the shape and/or the size of a touched area in correspondence with a finger or a stylus pen touch, and further comprises a hand feature information of the shape and/or the size of a touched area in correspondence with palm touch except fingers;
determining whether the touch action matching the finger feature information and the touch action matching the hand feature information are detected at the same time; and
waiting a predetermined duration to return to the step of detecting the touch action if a determine result of the determining is yes, then performing again the step of comparing the detected feature information with the standard feature information stored in the preset data storage, and performing a first process in correspondence with the finger feature information and/or a second process in correspondence with the hand feature information if a compare result of the comparing is still that the detected feature information matches the finger feature information and the hand feature information, otherwise the step of the touch action being detected is returned without performing the first process and/or the second process.

2. The method according to claim 1, wherein the first process is a normal touch responding processing, and the second process is to ignore the touch action and is not responding to the touch action made by hand.

3. The method according to claim 1, wherein the step of determining whether the touch action matching the finger feature information and the touch action matching the hand feature information are detected at the same time comprises:
determining whether the touch action matching the finger feature information and the touch action matching the hand feature information are detected at the same time, wherein the finger feature information comprises a touch feature information of the finger and the stylus pen.

4. A method for processing touch signal, comprising the steps of:
when a touch action is detected, collecting a detected feature information of a shape and/or a size of a touched area in correspondence with the touch action;
comparing the detected feature information with a standard feature information stored in a preset data storage, wherein the standard feature information comprises a finger feature information of the shape and/or the size of a touched area in correspondence with a finger or a stylus pen touch, and further comprises a hand feature information of the shape and/or the size of a touched area in correspondence with palm touch except fingers; and
performing a first process in correspondence with the finger feature information if a compare result of the comparing is that the detected feature information matches the finger feature information, and performing a second process in correspondence with the hand feature information if the compare result is that the detected feature information matches the hand feature information.

5. The method according to claim 4, wherein the first process is a normal touch responding processing, and the second process is to ignore the touch action and is not responding to the touch action made by hand.

6. The method according to claim 5, wherein, before performing the first process or the second process, the method comprises:
determining whether the touch action matching the finger feature information and the touch action matching the hand feature information are detected at the same time; and
if a determine result of the determining is yes, the first process and/or the second process is performed, otherwise the step of the touch action being detected is returned without performing the first process and/or the second process.

7. The method according to claim 6, wherein the step of determining whether the touch action matching the finger feature information and the touch action matching the hand feature information are detected at the same time comprises:
determining whether the touch action matching the finger feature information and the touch action matching the hand feature information are detected at the same time, wherein the finger feature information comprises a touch feature information of the finger and the stylus pen.

8. The method according to claim 5, wherein a step before the step of performing the first process, after the compare result is that the detected feature information matches the finger feature information, comprises:
waiting a predetermined duration to return to the step of detecting the touch action, then performing again the step of comparing the detected feature information with the standard feature information stored in the preset data storage, and performing the first process in correspondence with the finger feature information if the compare result is still that the detected feature information matches the finger feature information, and performing the second process in correspondence with the hand feature information if the compare result is still that the detected feature information matches the hand feature information.

9. A device for processing touch signal, comprising:
a detection module collecting a detected feature information of a shape and/or a size of a touched area in correspondence with a touch action when the touch action is detected;
a comparison module comparing the detected feature information with a standard feature information stored in a preset data storage; and
a processing module performing a first process in correspondence with a finger feature information if a compare result of the comparing of the comparison module is that the detected feature information matches the finger feature information, and performing a second process in correspondence with a hand feature information if the compare result is that the detected feature information matches the hand feature information.

10. The device according to claim 9, wherein the first process of the processing module is a normal touch responding processing, and the second process is to ignore the touch action and is not responding to the touch action made by hand.

11. The device according to claim 10, wherein the processing module further comprises:
a determination unit determining whether a touch action matching the finger feature information and a touch action matching the hand feature information are simultaneously detected before performing the first process or the second process; and
the processing module performs the first process and/or the second process if a determine result of the determination unit is yes, otherwise the processing module does not perform the first process and/or the second process.

12. The device according to claim 11, wherein the finger feature information comprises a touch feature information of a finger and a stylus pen.

13. The device according to claim 10, wherein, after a determine result of the determination module is that the detected feature information matches the finger feature information, and before the processing module performs the first process, a predetermined duration is waited and the comparison module compares the detected feature information with the standard feature information again; and, if the compare result of the comparison module is still that the detected feature information matches the finger feature information, the processing module performs the first process in correspondence with the finger feature information, and, if the compare result is still that the detected feature information matches the hand feature information, the processing module performs the second process in correspondence with the hand feature information.
